(19) United States
(12) Patent Application Publication
(10) Pub. No.: US 2020/0230608 A1
(43) Pub. Date: Jul. 23, 2020

(54) HORIZONTAL GRIND-TYPE GRAIN CLEANING MACHINE

(71) Applicant: SATAKE CORPORATION, Tokyo (JP)

(72) Inventors: Yasuyoshi SETO, Tokyo (JP); Shogo SUNADA, Tokyo (JP); Yuki HASHIMOTO, Tokyo (JP)

(73) Assignee: SATAKE CORPORATION, Tokyo (JP)

(21) Appl. No.: 16/486,925

(22) PCT Filed: Feb. 20, 2018
(86) PCT No.: PCT/JP2018/006005

§ 371 Date: Aug. 19, 2019

(30) Foreign Application Priority Data
Feb. 20, 2017 (JP) 2017-029325

(51) Int. Cl. B02B 3/06; B02B 7/00

(52) U.S. Cl. CPC B02B 3/06; B02B 7/00

(57) ABSTRACT

The horizontal grind-type grain cleaning machine is configured such that a milling roll is axially mounted to a main shaft provided freely rotatably in a polishing tube for bran removal, and one end of a polishing room with a main portion between the polishing tube for bran removal and the milling roll is connected to a grain supply portion, while another end is connected to a grain discharge portion. In the horizontal grind-type grain cleaning machine, a convex spiral vane for transferring grains from the grain supply portion to the grain discharge portion is fixedly mounted to an inner peripheral surface of the polishing tube for bran removal, and to the polishing tube for bran removal, a polishing room resistance body is provided for inhibiting movement of grains which move due to rotation of the milling roll when the polishing room resistance body is allowed to protrude to a side of the polishing room.

### TECHNICAL FIELD

The present invention relates to a horizontal grind-type grain cleaning machine.

### BACKGROUND ART

As conventional horizontal grind-type grain cleaning machines, there are those disclosed in Patent Literatures 1 to 6.

In these grain cleaning machines disclosed in Patent Literatures 1 to 6, an inclined spiral thread to guide grains such that the guided grains move forward while rotating in a rotation direction of a horizontal axis milling roll is provided at a part or the entire of an inner surface of a polishing tube with a porous wall which is formed on a polishing room by internally mounting the horizontal axis milling roll.

Due to this, such an operational effect is provided that, since the grains supplied to the polishing room are moderately guided along a spirally inclined edge of the spiral thread, no powerful feed roll is used even in a long-operation polishing room, and due to the spiral thread on the side of the polishing tube, a long-operation grind-type grain cleaning can be safely performed with no clogging and without occurrence of crushed rice.

However, the grain cleaning machines disclosed in Patent Literatures 1 to 6 have the configuration that a grain discharge port (polished rice outlet) is provided on a tip side of the polishing tube, and at the grain discharge port, a grain discharge shutter (on-off valve) is provided to cover the grain discharge port, and a resistance apparatus (weight) is provided to apply a pressure to the grain discharge shutter. Moreover, when grain feed is performed by a horizontal axis milling roll, pressure in the polishing room is controlled such that grains (polished rice) are discharged to the outside of the machine against the pressure of the grain discharge shutter.

Due to this, when the grains are desired to be finished with a low polishing accuracy, the degree of fullness at an upper side of a polishing room has been lowered because of a horizontal type, while the grains are desired to be finished with a high polishing accuracy, excess friction resistance tends to occur near the grain discharge port, which has introduced increase of a grain temperature or occurrence of mechanical crushed rice.

### CITATION LIST

### Patent Literature

### [Patent Literature 1]

Japanese Patent Publication No. S34-9322

### [Patent Literature 2]

Japanese Patent Publication No. S34-9323

### [Patent Literature 3]

Japanese Utility Model Publication No. S34-17152

### [Patent Literature 4]

Japanese Utility Model Publication No. S35-16671

### [Patent Literature 5]

Japanese Utility Model Publication No. S35-21882

### [Patent Literature 6]

International Publication No. WO2002/100546

### SUMMARY OF INVENTION

### Technical Problem

In view of the above problem, a technical object of the present invention is to provide a horizontal grind-type grain cleaning machine which makes a uniform inner pressure in the polishing room, prevents an uneven polishing when a low polishing accuracy is desired, and prevents occurrence of crushed rice when a high polishing accuracy is desired.

### Solution to Problem

To solve the above problem, according to one aspect of the present invention, such technical means is provided that, in a horizontal grind-type grain cleaning machine in which a milling roll is axially mounted to a main shaft provided freely rotatably in a polishing tube for bran removal, and one end of a polishing room with a main portion between the polishing tube for bran removal and the milling roll is connected to a grain supply portion, while another end is connected to a grain discharge portion, a convex spiral vane for transferring grains from the grain supply portion to the grain discharge portion is fixedly mounted to an inner peripheral surface of the polishing tube for bran removal, and to the polishing tube for bran removal, at least one polishing room resistance body is provided for inhibiting movement of grains which move due to rotation of the milling roll when the polishing room resistance body is allowed to protrude to a side of the polishing room.

Another aspect of the present invention is characterized in that the polishing room resistance body is an elongated plate and substantially L-shaped in a cross section, and the L-shaped polishing room resistance body has a base end portion supported to be rotatable, a tip portion which is close to an outer peripheral surface of the milling roll, and a bending portion which acts to inhibit movement of moving grains and apply resistance.

Another aspect of the present invention is characterized in that the polishing room resistance body is a resistance piece which is supported to be slidable and acts to inhibit movement of moving grains and apply resistance.

Another aspect of the present invention is characterized in that the resistance piece is supported via a member which reduces sliding resistance.

Another aspect of the present invention is characterized in that an air supply duct is provided to the polishing tube for bran removal such that a pressure feed air flow can be supplied to the side of the polishing room.

Another aspect of the present invention is characterized in that the polishing tube for bran removal is divided vertically into a plurality of divided portions, a connecting block portion for connecting the divided portions with each other is interposed among the plurality of divided portions, and the polishing room resistance body is provided in the connecting block portion.

Another aspect of the present invention is characterized in that the air supply duct is provided in the connecting block portion.

Another aspect of the present invention is characterized in that a plurality of grind-type grain cleaning machines described above are connectedly provided, wherein a first grind-type grain cleaning machine at an upper portion of a machine frame in a shape of a longitudinal box, a screw conveyer at a central portion of the machine frame, and a second grind-type grain cleaning machine at a lower portion of the machine frame in the shape of the longitudinal box are respectively arranged in a unified manner, thus forming a long-operation grain cleaning machine.

According to one aspect of the present invention, in a horizontal grind-type grain cleaning machine in which a milling roll is axially mounted to a main shaft provided freely rotatably in a polishing tube for bran removal, and one end of a polishing room with a main portion between the polishing tube for bran removal and the milling roll is connected to a grain supply portion, while another end is connected to a grain discharge portion, a convex spiral vane for transferring grains from the grain supply portion to the grain discharge portion is fixedly mounted to an inner peripheral surface of the polishing tube for bran removal, and to the polishing tube for bran removal, at least one polishing room resistance body is provided for inhibiting movement of grains which move due to rotation of the milling roll when the polishing room resistance body is allowed to protrude to a side of the polishing room. Consequently, rice grains receive a polishing operation while flowing to the side of the grain discharge portion (revolution or rotation) along the convex spiral vane provided on the inner peripheral surface of the polishing tube for bran removal. As a result, such inconveniences are eliminated as occurrence of clogging by securing a stable flow rate or generation of crushed rice.

On the other hand, if finishing with a low polishing accuracy is desired, the degree of fullness at an upper side of the polishing room is lowered because of a horizontal type, which could generate poor polishing.

However, at this time, the plurality of polishing room resistance bodies arranged in the polishing room protrude to the side of the milling roll, and the polishing room resistance body inhibits the movement of the grains. The grains are applied resistance which inhibits movement in a circumferential direction in the polishing room, the degree of fullness of the polishing room is stabilized by a receiving operation of the grains, and due to a synergetic effect with a feed operation of the spiral vane, poor polishing does not occur, and bran attached to the grains can be fully removed.

On the other hand, when a high polishing accuracy is desired, when the spiral vane is provided, such a problem occurs that excess friction resistance tends to occur near the grain discharge port, which introduces increase of a grain temperature or occurrence of mechanical crushed rice.

However, in such a case, a plurality of polishing room resistance bodies arranged in the polishing room are retracted to the opposite side from the milling roll to be removed from the outer peripheral surface of the milling roll, which mitigates capturing of the grains. This inhibits occurrence of excess friction resistance to prevent occurrence of crushed rice.

Additionally, an air supply duct is provided to the polishing tube for bran removal such that a pressure feed air flow can be supplied to the side of the polishing room, which achieves the configuration that air blowing can be positively performed into the polishing room. Due to this, bran powders attached to the rice grins can be fully removed, and a cooling effect of the rice grains can be remarkably improved.

### Advantageous Effect of Invention

According to the present invention, a horizontal grind-type grain cleaning machine which makes a uniform inner pressure in the polishing room, prevents an uneven polishing when a low polishing accuracy is desired, and prevents occurrence of crushed rice when a high polishing accuracy is desired can be provided.

### BRIEF DESCRIPTION OF DRAWINGS

FIG. 1 shows a schematic perspective view showing an appearance of a horizontal grind-type grain cleaning machine according to the present invention.

FIG. 2 shows a perspective view when a grain cleaning portion cover is removed and a polishing tube appears.

FIG. 3 shows a schematic front view of FIG. 2.

FIG. 4 shows a schematic vertical cross-sectional view showing an internal structure.

FIG. 5 shows a schematic vertical cross sectional view when vertical breaking is performed at the center in FIG. 4.

FIG. 6 shows a partial enlarged view of FIG. 4.

FIG. 7 shows a perspective view of a half portion when the polishing tube is halved vertically.

FIG. 8 shows a perspective view showing the entire polishing tube.

FIG. 9 shows a perspective view showing the entire connecting block portion.

FIG. 10 shows an explanation view of an embodiment which uses a direct acting type polishing room resistance body.

FIG. 11 shows an explanation view when a portion of a chain line is enlarged in FIG. 10.

FIG. 12 shows an explanation view of a resistance apparatus which uses the direct acting type polishing room resistance body.

FIG. 13 shows an explanation view of the resistance apparatus which uses the direct acting type polishing room resistance body (the bottom side).

FIG. 14 shows an explanation view of the resistance apparatus which uses the direct acting type polishing room resistance body (the upper side).

FIG. 15 is a drawing showing the state of a resistance piece before operation.

FIG. 16 is a drawing showing the state of the resistance piece after operation.

FIG. 17 is an explanation view of another resistance apparatus which uses a direct acting type polishing room resistance body.

FIG. 18 shows a diagram for explaining supply of blast to a bran removal room and blast to an inner portion of a polishing room.

### DESCRIPTION OF EMBODIMENTS

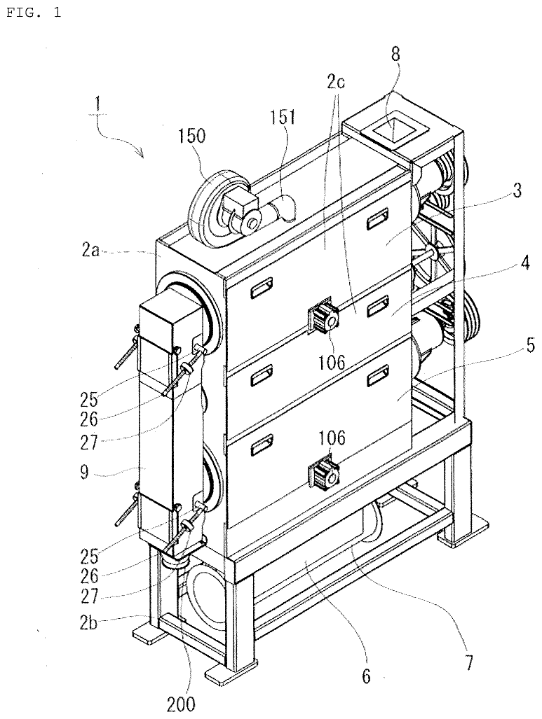

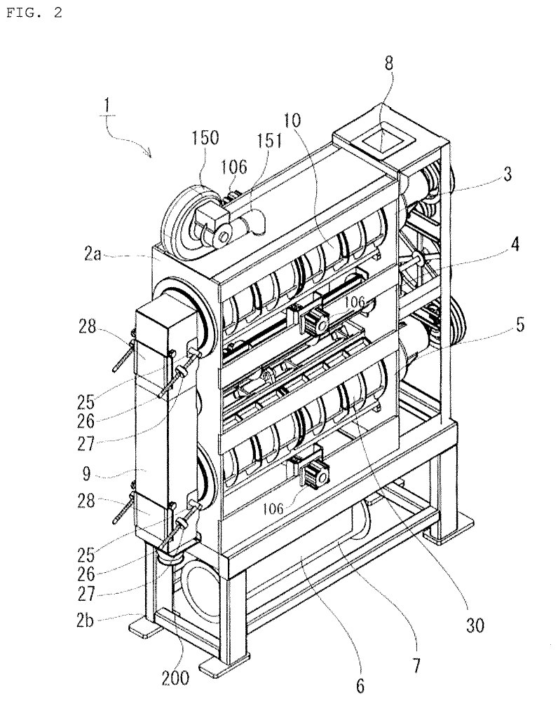

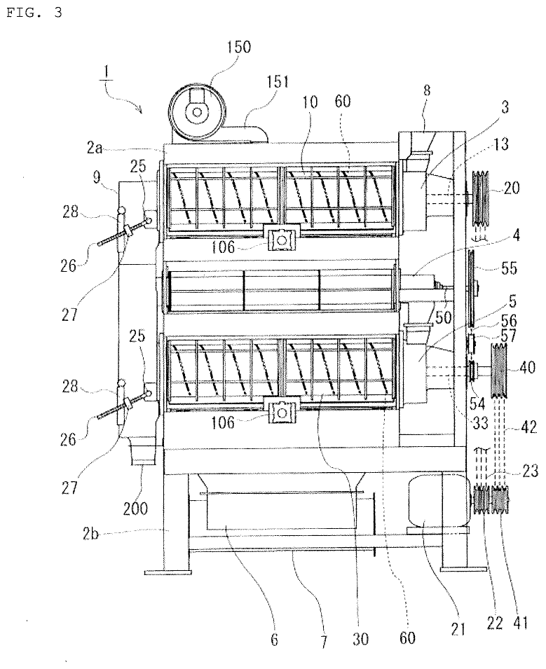

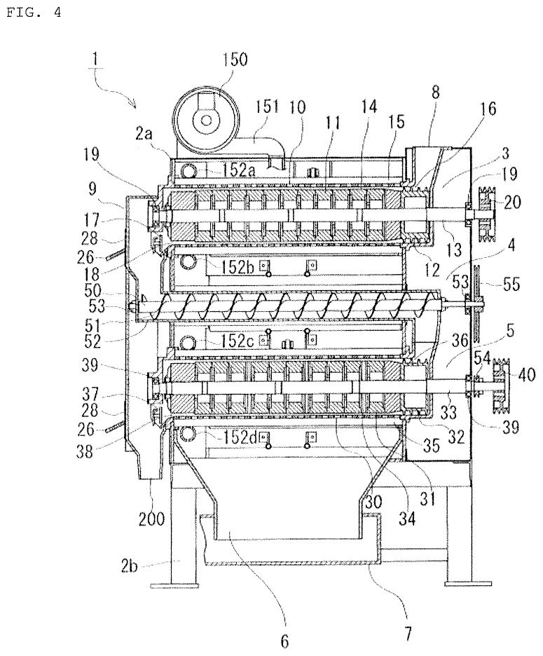

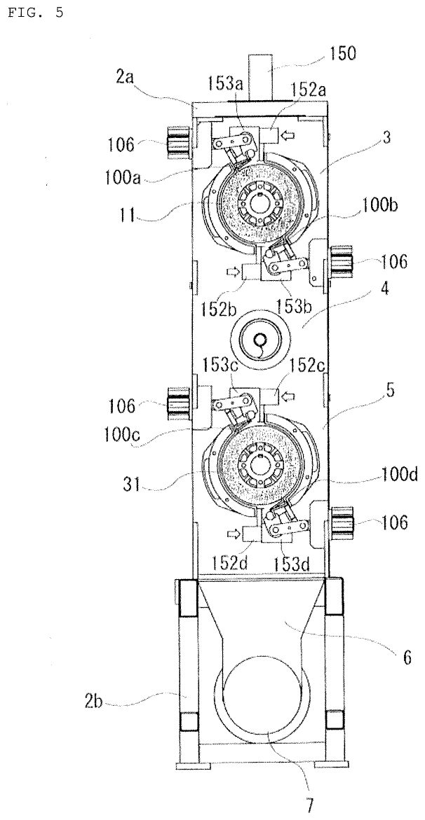

Hereinafter, a preferred embodiment according to the present invention will be explained with reference to the drawings. FIG. 1 is a schematic perspective view showing an appearance of a horizontal grind-type grain cleaning machine according to the present invention, FIG. 2 shows a perspective view when a grain cleaning portion cover is removed and a polishing tube appears, FIG. 3 shows a schematic front view of FIG. 2, and FIG. 4 shows a schematic vertical cross-sectional view showing an internal structure.

As shown in FIGS. 1 to 4, a horizontal grind-type grain cleaning machine 1 according to an embodiment of the present invention has a main portion constituted by a horizontal first grind-type grain cleaning machine 3 arranged at an upper portion of a machine frame 2a in the shape of a longitudinal box, a screw conveyer 4 arranged below the first grind-type grain cleaning machine 3 at a central portion of the machine frame 2a and a horizontal second grind-type grain cleaning machine 5 arranged below the screw conveyer 4 at a lower portion of the machine frame 2a. The first grind-type grain cleaning machine 3, the screw conveyer 4 and the second grind-type grain cleaning machine 5 are arranged in parallel vertically in a unified manner, thus forming a long-operation grain cleaning machine in which polishing is completed by only one passage of grains.

Below the machine frame 2a, a bran collecting hopper 6 which collects bran from the first grind-type grain cleaning machine 3 and the second grind-type grain cleaning machine 5. At a lower portion of the bran collecting hopper 6, a dust collecting pipe 7 for connecting to a dust collection apparatus such as a bug filter which is outside of the drawing is provided. A material supply hopper 8 is provided at one side of an upper portion of the machine frame 2a, and a grain discharge portion 9 in which a resistance apparatus (weight) is internally mounted is provided at the other side of the upper portion of the machine frame 2a. Reference numeral 2b denotes a frame which is a seating of the machine frame 2a, reference numeral 2c denotes a grain cleaning portion cover and reference numeral 200 denotes a polished product discharge port.

Next, an internal configuration of the first grind-type grain cleaning machine 3 will be explained in detail. As shown in FIGS. 3 and 4, the first grind-type grain cleaning machine 3 has a polishing tube with a porous wall for bran removal 10 which is wire mesh for grain cleaning bridged laterally in the machine frame 2a, and a milling roll 11 for milling and a spiral roll 12 for feeding are coaxially provided around the same rotation shaft 13 in the polishing tube 10 rotatably. Moreover, while a polishing room 14 is formed between the milling roll 11 and the polishing tube 10, while a bran removal room 15 is formed outside of the polishing tube 10. A material supply port 16 is provided at one side of the polishing room 14 and, at the other side of the polishing room 14, a resistance lid 17 for closing the polishing room 14 and a grain discharge port 18 at an inner side of the resistance lid 17 are respectively provided.

The rotation shaft 13 has both ends supported by bearings 19, 19, and is formed to be rotatable by a first pulley 20 axially mounted on its one end. That is, as shown in FIG. 3, a motor 21 for driving is installed on the frame 2b, and a belt 23 is wound between a first motor pulley 22 axially mounted to a motor shaft of the motor 21 and the first pulley 20. This achieves the configuration in which a rotational force of the motor 21 can be transmitted to the rotation shaft 13.

An internal configuration of the second grind-type grain cleaning machine 5 has the same configuration as in the first grind-type grain cleaning machine 3. That is, in the second grind-type grain cleaning machine 5, reference numeral 30 denotes the polishing tube with a porous wall for bran removal, reference numeral 31 denotes the milling roll, reference numeral 32 denotes the spiral roll, reference numeral 33 denotes the rotation shaft, reference numeral 34 denotes the polishing room, reference numeral 35 denotes the bran removal room, reference numeral 36 denotes the material supply port, reference numeral 37 denotes the resistance lid and reference numeral 38 denotes the grain discharge port.

The rotation shaft 33 has both ends supported by bearings 39, 39 and is formed to be rotatable by a second pulley 40 axially mounted on its one end. As shown in FIG. 3, a belt 42 is wound between a second motor pulley 41 axially mounted to the motor shaft of the motor 21 and the second pulley 40. This achieves the configuration in which a rotational force of the motor 21 can be transmitted to the rotation shaft 33.

The screw conveyer 4 has a conveyer case 52 which houses a screw shaft 50 and a screw vane 51 axially mounted to the screw shaft 50, and is formed to be rotatable by bearings 53, 53. As shown in FIG. 3, such a configuration can be made that a rotational force can be transmitted to the screw shaft 50 via a belt 56 and a tension 57 to a portion between a fourth pulley 55 axially mounted to the screw shaft 50 and a third pulley 54 axially mounted to the rotation shaft 33.

As shown in FIGS. 1 to 4, in the grain discharge portion 9, a resistance apparatus (weight) is internally mounted for adjusting the degree of compression of the resistance lid 17. As the resistance apparatus, for example, such a configuration can be made that levers 26, 26 are axially mounted to pivot shafts 25, 25 of the resistance lids 17, 37, respectively, and weights 27, 27 are fitted to the levers 26, 26, respectively. Alternatively, the resistance apparatus by an air cylinder etc. may be adopted. Moreover, sample collection doors 28, 28 are provided at the grain discharge portion 9.

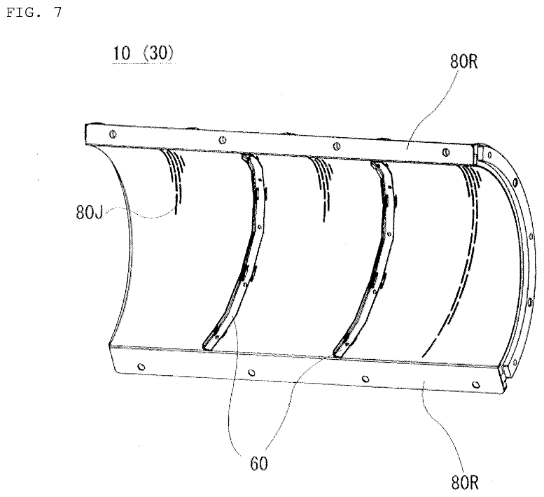

As shown in FIGS. 3, 6, 7 and 8, to the first grind-type grain cleaning machine 3 and the second grind-type grain cleaning machine 5 in the embodiment, a convex spiral vane 60 for transferring grains from the material supply port 16 to the grain discharge port 18 is provided at an inner peripheral surface of the polishing tube 10 (in FIG. 3, an operation is provided to transfer grains to the left side of the paper.). Regarding the spiral vane 60, in the schematic front view of FIG. 3, it can be seen that multiple inclined spiral vanes 60 are continuously provided, in FIG. 7, it can be seen that the spiral vane 60 protrudes from a wire-mesh surface of the polishing tube 10, and in the perspective view of FIG. 8, it can be seen that the arc of the spiral vane 60 is drawn on the inner peripheral surface of the polishing tube 10.

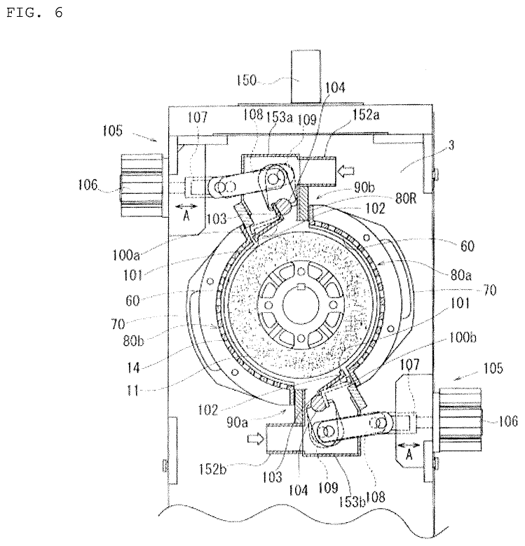

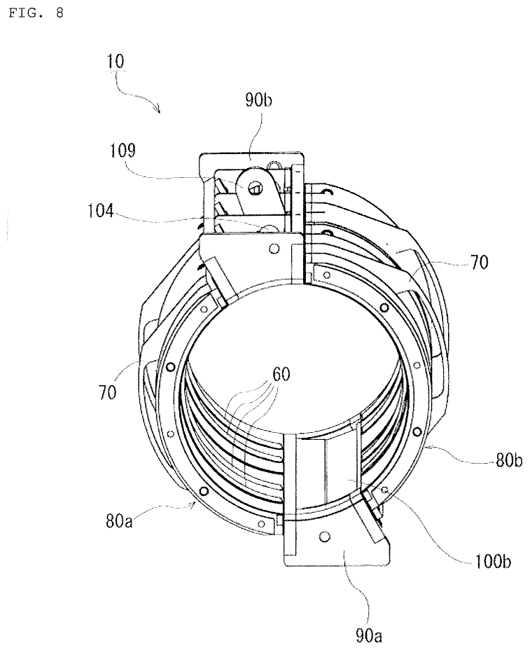

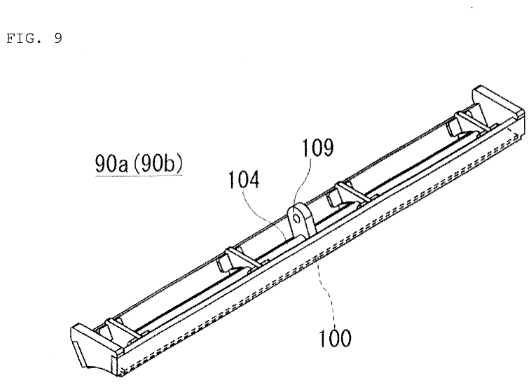

As shown in FIGS. 6, 7 and 8, in this embodiment, the polishing tube 10 (30) is formed by a combination of half portions 80a, 80b made by dividing a cylindrical tube including a number of bran removal holes 80J vertically into two halves. In these half portions 80a, 80b, each of both lateral ends 80R of the half portions 80a, 80b is fixed by connecting block portions 90a, 90b. In the connecting block portions 90a, 90b, polishing room resistance bodies 100a, 100b which can protrude to the side of the polishing room 14 (34) are provided. Moreover, the polishing room resistance body 100 is an elongated plate extending in an axial direction of the horizontal milling roll 11 (31) (FIGS. 8 and FIG. 9), and is bent to be hook-like in its cross section (FIG. 6). That is, as seen in FIG. 6, the polishing room resistance bodies 100a, 100b are formed to be substantially L-shaped in its cross section. However, these polishing room resistance plates 100a, 100b are not limited to L-shaped, and any shape is applicable as long as it is hook-like, for example, various shapes such as a “dog-leg” shape, a “J-letter” shape or a “U-letter” shape seen in its cross section may be adopted.

Additionally, reference numeral 70 denotes a handle when the half portions 80a, 80b are disassembled or assembled.

In the polishing room resistance body 100, a tip portion 101 is close to an outer peripheral surface of the milling roll 11 (31) (FIG. 6). At this time, the tip portion 101 is directed to a center direction (a direction of the rotation shaft 13 (33)). Also, a bending portion 102 of the tip portion 101 serves as applying resistance to inhibit grains which move due to rotation of the milling roll 11 (31). Moreover, a base end portion 103 on the other side of tip portion 100 is axially mounted to a shaft 104 which is internally provided to the connecting block portions 90a, 90b to be rotatably supported.

That is, a biasing apparatus 105 is provided to the polishing room resistance plate 100. The biasing apparatus 105 is an air actuator, and as shown in FIG. 6, the biasing apparatus 105 is constituted by an air cylinder 106, a movable rod 107, a connection lever 108 and a pivot piece 109 etc. The polishing room resistance plate 100 has an end rotatably supported by the shaft 104 which is internally provided to the connecting block portions 90a, 90b to be rotatably supported, and pivots around the shaft 104 due to advancement or retraction of the movable rod 107 (an arrow A of FIG. 6) to be able to adjust the access distance between the tip portion 101 and the outer peripheral surface of the milling roll 11 (31).

A branch tube is connected to the air cylinder 106 from a compressor via a regulator (both are not shown) to supply air pressure to an inner portion of the air cylinder 106. This air pressure can be adjusted by the regulator. Consequently, each polishing room resistance plate 100 receives the air pressure and is pivoted around the shaft 104 to inhibit moving of the grains.

Also, in the horizontal grind-type grain cleaning machine 1 of this embodiment, a pressure feed fan 150 is provided above the machine frame 2a to achieve the configuration that air blowing can be positively performed into the polishing room 10 (30) via air supply ducts 152a, 152b, 152c and 152d provided to the connecting block portions 90a, 90b. That is, the pressure feed fan 150 is provided above the machine frame 2a, and air supply is dividedly executed from the fan duct 151 of the pressure feed fan 150 to the air supply ducts 152a, 152b of the first grind-type grain cleaning machine 3 and the air supply ducts 152c, 152d of the second grind-type grain cleaning machine 5, respectively.

To the connecting block 90a, 90b, together with the air supply ducts 152a, 152b, 152c and 152d, air chambers 153a, 153b, 153c and 153d communicating with the polishing room 10 are respectively provided. That is, the fan duct 151 of the pressure feed fan 150 is connected to the air supply ducts 152a, 152b, 152c and 152d via a communication tube (not shown) etc., and a pressure feed air flow is sent to the polishing room 10 via the air chambers 153a, 153b, 153c and 153d.

Due to this, both bran removal efficiency and cooling efficiency can be improved in the first grind-type grain cleaning machine 3 and the second grind-type grain cleaning machine 5.

Hereinafter, a concrete operation in this embodiment will be explained. Material rice grains (brown rice) to be supplied to the material supply hopper 8 of the first grind-type grain cleaning machine 3 (see FIGS. 1 to 4) are adjusted to an appropriate supply flow rate by the spiral roll 12 from the material supply port 16 and supplied to the polishing room 14.

In the polishing room 14, the material rice grains contact to abrasive grains on a periphery surface of the milling roll 11 due to rotation of the milling roll 11, so that surface layers of the rice grains are ground. At this time, in the polishing room 14, the rice grains receive a grain cleaning operation while flowing to the side of the grain discharge port 18 (revolution or rotation) along the spiral vane 60 provided on the inner peripheral surface of the polishing tube 10. Consequently, in the polishing room 14, the grains are introduced to the side of the grain discharge port 18 to move forward while being rotated in a rotation direction of the milling roll 11. As a result, such inconveniences are eliminated as occurrence of clogging by securing a stable flow rate or generation of crushed rice.

On the other hand, when grain cleaning is performed by the horizontal axis milling roll 11 even when the spiral vane 60 is provided, if finishing with a low polishing accuracy is desired, the degree of fullness at an upper side of the polishing room is lowered because of a horizontal type, which could generate poor polishing.

However, at this time, the plurality of polishing room resistance bodies 100 arranged in the polishing room 14 protrudes to the side of the milling roll 11 due to contraction of the movable rod 107 of the air cylinder 106, the tip portion 101 of each polishing room resistance body 100 is close to the outer peripheral surface of the milling roll 11. Due to this, grains which move along the milling roll 11 are captured, and the material rice grains supplied to the polishing room 14 move to the side of the bending portion 102 of the polishing room resistance body 100 to inhibit the movement of the grains. At this time, the grains are applied a resistance which inhibits movement in a circumferential direction in the polishing room 14 (see FIG. 6).

In this embodiment, the tip portion 101 of the polishing room resistance body 100 is close to the outer peripheral surface of the milling roll 11 and the grains are captured at the bending portion 102. Accordingly, the degree of fullness of the polishing room 14 is stabilized by a receiving operation of the grains, and due to a synergetic effect with a feed operation of the spiral vane 60, poor polishing does not occur, and bran attached to the grains can be fully removed.

On the other hand, when a high polishing accuracy is desired, when the spiral vane 60 is provided, such a problem occurs that excess friction resistance tends to occur near the grain discharge port, which introduces increase of a grain temperature or occurrence of mechanical crushed rice.

However, in such a case, the movable rod 107 of the air cylinder 106 extends to retract to the opposite side from the milling roll 11, and the tip portion 101 of the polishing room resistance body 100 is removed from the outer peripheral surface of the milling roll 11, which mitigates capturing of the grains which move along the milling roll 11. This inhibits occurrence of excess friction resistance to prevent occurrence of crushed rice (see FIG. 6).

Incidentally, in this embodiment (see FIG. 6), the pressure feed fan 150 is provided to achieve the configuration that air blowing can be positively performed into the polishing room 10 (30). Due to this, bran powders attached to the rice grains in the first grind-type grain cleaning machine 3 and the second grind-type grain cleaning machine 5 can be fully removed, and a cooling effect of the rice grains can be remarkably improved.

As explained above, in this embodiment, in the horizontal grind-type grain cleaning machine 1 in which the milling roll 11 is axially mounted to the main shaft 13 provided freely rotatably in the polishing tube for bran removal 10, and one end of the polishing room 14 with a main portion between the polishing tube for bran removal 10 and the milling roll 11 is connected to the grain supply portion 16, while the other end is connected to the grain discharge portion 188, the convex spiral vane 60 for transferring grains from the grain supply portion 16 to the grain discharge portion 18 is fixedly mounted to an inner peripheral surface of the polishing tube for bran removal 10, and to the polishing tube for bran removal 10, a plurality of polishing room resistance bodies 100 are provided for inhibiting movement of grains which move due to rotation of the milling roll 11 when the polishing room resistance bodies 100 are allowed to protrude to a side of the polishing room 14. Consequently, the following operational effects are provided.

When finishing with a low polishing accuracy is desired (rice with a low whiteness degree etc.), the degree of fullness at an upper side of the polishing room tends to be lowered because of a horizontal type. However, the polishing room resistance body 100 provided in the polishing tube for bran removal 10 protrudes to the side of the milling roll 11, and the polishing room resistance body 100 inhibits the movement of the grains. Accordingly, the degree of fullness of the polishing room 14 is stabilized by the receiving operation of the grains, and due to the synergetic effect with a feed operation of the spiral vane 60, poor polishing does not occur, and bran attached to the grains can be fully removed.

When finishing with a high polishing accuracy (polishing to rice with a high degree of whiteness etc.) is desired, when the spiral vane 60 is provided, excess friction resistance tends to occur near the grain discharge port, which introduces increase of a grain temperature or occurrence of mechanical crushed rice. However, the polishing room resistance body 100 provided in the polishing tube for bran removal 10 retracts to the opposite side from the milling roll 11, and the polishing room resistance body 100 is removed from the outer peripheral surface of the milling roll 11, which mitigates capturing of the grains. This inhibits occurrence of excess friction resistance to prevent occurrence of crushed rice.

In the above embodiment, the polishing room resistance body 100 has an end rotatably supported by the shaft 104 which is internally provided to the connecting blocks 90a, 90b. The polishing room resistance body 100 pivots around the shaft 104 due to advancement or retraction of the movable rod 107 to be able to adjust the access distance between the tip portion 101 and the outer peripheral surface of the milling roll 11 (31).

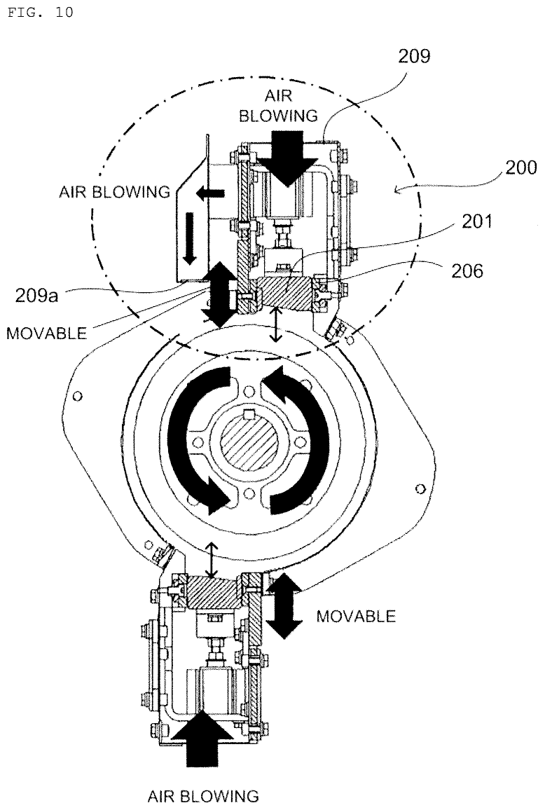

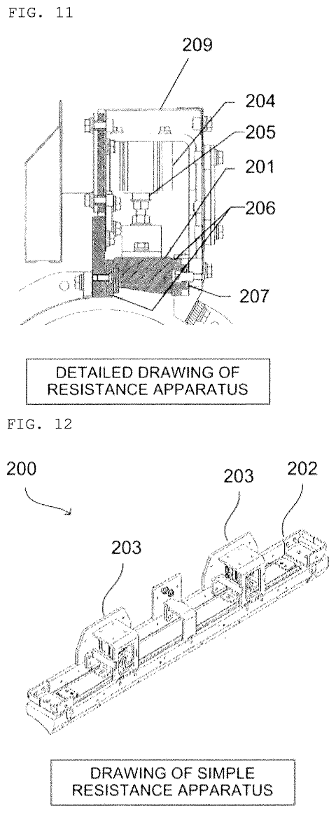

As the resistance body to apply resistance which inhibits movement of the grains in a circumferential direction of the polishing room 14, a direct acting type polishing room resistance body may be used. FIG. 10 is an explanation view of an embodiment which uses the direct acting type polishing room resistance body. FIG. 11 is an explanation view when a portion of a chain line is enlarged in FIG. 10. FIGS. 12, 13 and 14 are perspective views for explaining a resistance apparatus which uses the direct acting type polishing room resistance body.

A resistance apparatus 200 is attached to the horizontal grind-type grain cleaning machine 1. For example, in FIGS. 6, 7 and 8, instead of the connecting block portions 90a, 90b, the resistance apparatus 200 of this embodiment can be respectively used. The resistance apparatus 200 includes a longitudinal resistance piece 201 which is a direct acting type polishing room resistance body and a strut 202 which supports the resistance piece 201 slidably. As shown in FIGS. 12, 13 and 14, the strut 202 has a longitudinal frame structure, and can house the resistance piece 201 in its inner portion. A fixing portion 203 for fixing an air cylinder is provided on both lateral end portions of the strut 202. The resistance piece 201 is connected to a rod 205 of the air cylinder 204 attached to the fixing portion 203.

The resistance piece 201 which is the direct acting type polishing room resistance body can adjust the access distance of the resistance piece 201 to the outer peripheral surface of the milling roll 11 (31) when it is allowed to move linearly using driving means such as the air cylinder 204, not rotation. That is, the access distance of the resistance piece 201 to the outer peripheral surface of the milling roll 11 (31) can be adjusted by contracting the rod 205 of the air cylinder 204.

A member which lowers sliding resistance to make sliding of the resistance piece 201 easy is arranged at an inner surface of the strut 202 facing the outer periphery of the resistance piece 201. As the member which lowers the sliding resistance, a super-high-molecular polyethylene 206 is arranged. The high molecular polyethylene 206 is attached to the inner surface of the strut 202 by fixing means such as a screw. Alternatively, the super-high-molecular polyethylene 206 may be attached to a side surface of the resistance piece 201. Alternatively, the super-high-molecular polyethylene 206 may be provided on both portions of the resistance piece 201 and an inner surface of the strut 202.

FIG. 11 shows the embodiment in which, among the super-high-molecular polyethylene 206 arranged on the inner surface of the strut 202, the super-high-molecular polyethylene 206 arranged on at least one surface is attached to the strut 202 via a wave washer 207 having elasticity. This configuration achieves the configuration in which the super-high-molecular polyethylene 206 is movable, which makes attachment of the resistance piece 201 easy. Additionally, the member having elasticity is not limited to the wave washer 207.

Also, the super-high-molecular polyethylene 206 supported by the wave washer 207 is arranged in a frame provided at a lateral side of the strut 202, which achieves the configuration that the super-high-molecular polyethylene 206 is automatically pushed out even when it is worn away. This prevents generation of a gap between the resistance piece 201 and the super-high-molecular polyethylene 206.

In the embodiment in which the direct acting type polishing room resistance body is used, the gap between the polishing room resistance body and a member for supporting the same can be easily managed compared to the embodiment in which the rotation type polishing room resistance body is used. The direct acting type polishing room resistance body is easily attached to the resistance apparatus 200 due to the configuration of the movable super-high-molecular polyethylene 202.

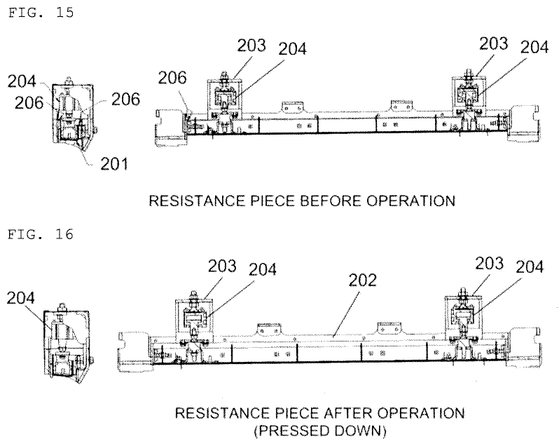

FIG. 15 is a drawing showing the state of the resistance piece 201 before operation. FIG. 16 is a drawing showing the state that the resistance piece 201 protrudes to the side of the polishing room 14 by the driving of the air cylinder 204. Additionally, a branch tube is connected to the air cylinder 204 from a compressor via a regulator (both are not shown) to supply air pressure to an inner portion of the air cylinder 204. This air pressure can be adjusted by the regulator. Consequently, each polishing room resistance piece 201 receives the air pressure to advance or retract in the direction of the polishing room 14 and inhibits moving of the grains.

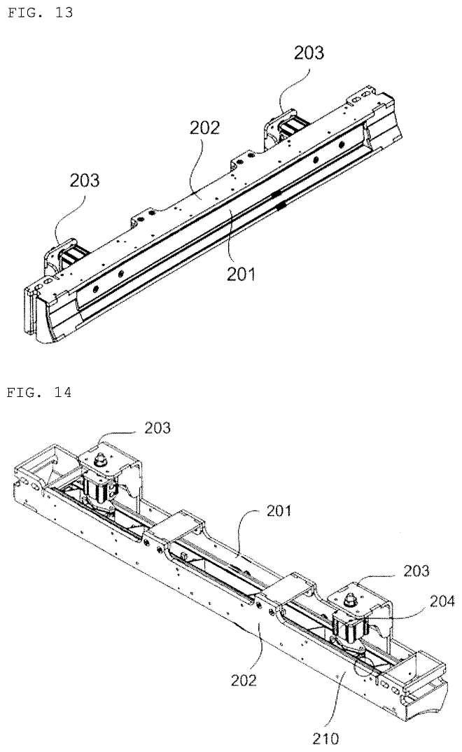

As shown in FIG. 14, a groove is formed in the strut 202 of the resistance apparatus 200. An air chamber 209 is provided to cover the groove 208. In the same manner as shown in FIG. 6, the air chamber 209 is configured such that air blowing from the pressure feed fan 150 can be executed to the polishing room 14 formed in the polishing tube 10 and an upper portion of the polishing tube 10. Air blowing from a blast port 209a of the air chamber 209 can eliminate bran which accumulates on the upper portion of the polishing tube 10.

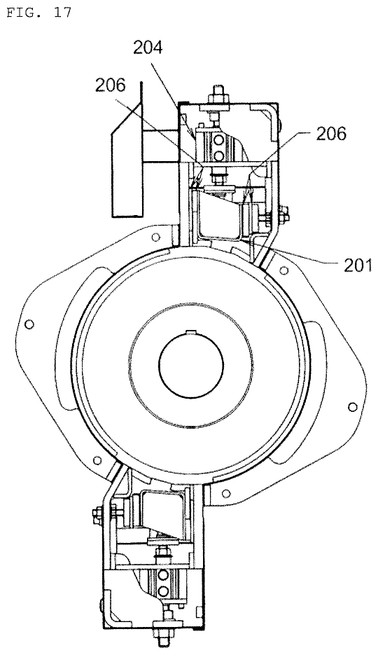

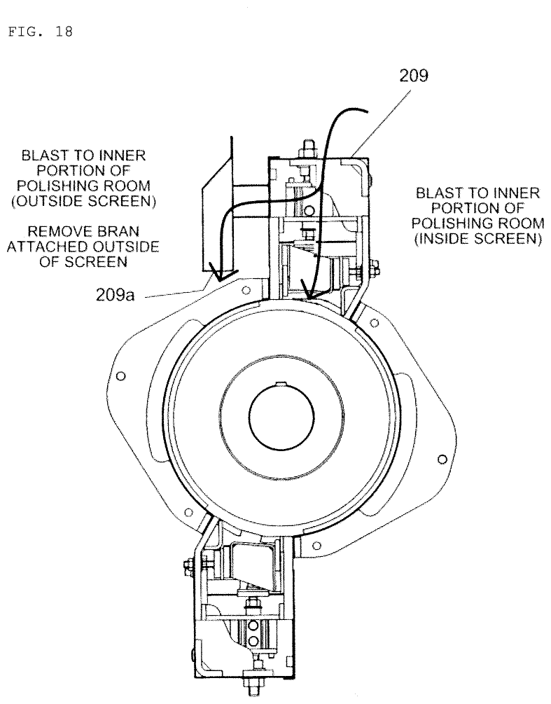

As shown in FIG. 17, the super-high-molecular polyethylene may be provided on both portions of the side surface of the resistance piece 201 and an inner surface the strut 202. Also in FIG. 18, in the same manner as shown in FIG. 6, it is configured that air blowing from the pressure feed fan 150 can be executed to the polishing room 14 formed in the polishing tube 10 and the upper portion of the polishing tube 10.

### INDUSTRIAL APPLICABILITY

The present invention can be applied to a vertical or horizontal grain cleaning machine.

### REFERENCE SIGNS LIST

1 horizontal grind-type grain cleaning machine
2a machine frame
2b frame
2c grain cleaning portion cover
3 first grind-type grain cleaning machine
4 screw conveyer
5 second grind-type grain cleaning machine
6 bran collecting hopper
7 dust collecting pipe
8 material supply hopper
9 grain discharge portion
10 polishing tube with a porous wall for bran removal
11 milling roll
12 spiral roll
13 rotation shaft
14 polishing room
15 bran removal room
16 material supply port
17 resistance lid
18 grain discharge port
19 bearing
20 first pulley
21 motor
22 first motor pulley
23 belt
25 pivot shaft
26 lever
27 weight
28 sample collection door
30 polishing tube with a porous wall for bran removal
31 milling roll
32 spiral roll
33 rotation shaft
34 polishing room
35 bran removal room
36 material supply port
37 resistance lid
38 grain discharge port
39 bearing
40 second pulley
41 second motor pulley
42 belt
45 pivot shaft
50 screw shaft
51 screw vane
52 conveyer case
53 bearing
54 third pulley
55 fourth pulley
56 belt
57 tension
60 spiral vane
70 handle
80 half portion
90 connecting block portion
100 polishing room resistance body
101 tip portion
102 bending portion
103 base end portion
104 shaft
105 biasing apparatus
106 air cylinder
107 movable rod
108 connection lever
109 pivot piece
150 pressure feed fan
151 fan duct
152 air supply duct
153 air chamber
200 resistance apparatus
201 resistance piece
202 strut
203 fixing portion
204 air cylinder
205 rod
206 super-high-molecular polyethylene
207 wave washer
208 groove
209 air chamber
209a blast port
210 groove

1. A horizontal grind-type grain cleaning machine in which a milling roll is axially mounted to a main shaft provided freely rotatably in a polishing tube for bran removal, and one end of a polishing room with a main portion between the polishing tube for bran removal and the milling roll is connected to a grain supply portion, while another end is connected to a grain discharge portion, wherein
a convex spiral vane for transferring grains from the grain supply portion to the grain discharge portion is fixedly mounted to an inner peripheral surface of the polishing tube for bran removal, and
to the polishing tube for bran removal, at least one polishing room resistance body is provided for inhibiting movement of grains which move due to rotation of the milling roll when the polishing room resistance body is allowed to protrude to a side of the polishing room.

2. The horizontal grind-type grain cleaning machine according to claim 1, wherein the polishing room resistance body is an elongated plate and substantially L-shaped in a cross section, and the L-shaped polishing room resistance body has a base end portion supported to be rotatable, a tip portion which is close to an outer peripheral surface of the milling roll, and a bending portion which acts to inhibit movement of moving grains and apply resistance.

3. The horizontal grind-type grain cleaning machine according to claim 1, wherein the polishing room resistance body is a resistance piece which is supported to be slidable and acts to inhibit movement of moving grains and apply resistance.

4. The horizontal grind-type grain cleaning machine according to claim 3, wherein the resistance piece is supported via a member which reduces sliding resistance.

5. The horizontal grind-type grain cleaning machine according to claim 1, wherein an air supply duct is provided to the polishing tube for bran removal such that a pressure feed air flow can be supplied to the side of the polishing room.

6. The horizontal grind-type grain cleaning machine according to claim 1, wherein the polishing tube for bran removal is divided vertically into a plurality of divided portions, a connecting block portion for connecting the divided portions with each other is interposed among the plurality of divided portions, and the polishing room resistance body is provided in the connecting block portion.

7. The horizontal grind-type grain cleaning machine according to claim 6, wherein the air supply duct is provided in the connecting block portion.

8. A horizontal grind-type grain cleaning machine in which a plurality of horizontal grind-type grain cleaning machines according to claim 1 are connectedly provided, wherein a first grind-type grain cleaning machine at an upper portion of a machine frame in a shape of a longitudinal box, a screw conveyer at a central portion of the machine frame, and a second grind-type grain cleaning machine at a lower portion of the machine frame in the shape of the longitudinal box are respectively arranged in a unified manner, thus forming a long-operation grain cleaning machine.

9. The horizontal grind-type grain cleaning machine according to claim 2, wherein an air supply duct is provided to the polishing tube for bran removal such that a pressure feed air flow can be supplied to the side of the polishing room.

10. The horizontal grind-type grain cleaning machine according to claim 3, wherein an air supply duct is provided to the polishing tube for bran removal such that a pressure feed air flow can be supplied to the side of the polishing room.

11. The horizontal grind-type grain cleaning machine according to claim 4, wherein an air supply duct is provided to the polishing tube for bran removal such that a pressure feed air flow can be supplied to the side of the polishing room.

12. The horizontal grind-type grain cleaning machine according to claim 2, wherein the polishing tube for bran removal is divided vertically into a plurality of divided portions, a connecting block portion for connecting the divided portions with each other is interposed among the plurality of divided portions, and the polishing room resistance body is provided in the connecting block portion.

13. The horizontal grind-type grain cleaning machine according to claim 3, wherein the polishing tube for bran removal is divided vertically into a plurality of divided portions, a connecting block portion for connecting the divided portions with each other is interposed among the plurality of divided portions, and the polishing room resistance body is provided in the connecting block portion.

14. The horizontal grind-type grain cleaning machine according to claim 4, wherein the polishing tube for bran removal is divided vertically into a plurality of divided portions, a connecting block portion for connecting the divided portions with each other is interposed among the plurality of divided portions, and the polishing room resistance body is provided in the connecting block portion.

15. The horizontal grind-type grain cleaning machine according to claim 5, wherein the polishing tube for bran removal is divided vertically into a plurality of divided portions, a connecting block portion for connecting the divided portions with each other is interposed among the plurality of divided portions, and the polishing room resistance body is provided in the connecting block portion.

16. A horizontal grind-type grain cleaning machine in which a plurality of horizontal grind-type grain cleaning machines according to claim 2 are connectedly provided, wherein a first grind-type grain cleaning machine at an upper portion of a machine frame in a shape of a longitudinal box, a screw conveyer at a central portion of the machine frame, and a second grind-type grain cleaning machine at a lower portion of the machine frame in the shape of the longitudinal box are respectively arranged in a unified manner, thus forming a long-operation grain cleaning machine.

17. A horizontal grind-type grain cleaning machine in which a plurality of horizontal grind-type grain cleaning machines according to claim 3 are connectedly provided, wherein a first grind-type grain cleaning machine at an upper portion of a machine frame in a shape of a longitudinal box, a screw conveyer at a central portion of the machine frame, and a second grind-type grain cleaning machine at a lower portion of the machine frame in the shape of the longitudinal box are respectively arranged in a unified manner, thus forming a long-operation grain cleaning machine.

18. A horizontal grind-type grain cleaning machine in which a plurality of horizontal grind-type grain cleaning machines according to claim 4 are connectedly provided, wherein a first grind-type grain cleaning machine at an upper portion of a machine frame in a shape of a longitudinal box, a screw conveyer at a central portion of the machine frame, and a second grind-type grain cleaning machine at a lower portion of the machine frame in the shape of the longitudinal box are respectively arranged in a unified manner, thus forming a long-operation grain cleaning machine.

19. A horizontal grind-type grain cleaning machine in which a plurality of horizontal grind-type grain cleaning machines according to claim 5 are connectedly provided, wherein a first grind-type grain cleaning machine at an upper portion of a machine frame in a shape of a longitudinal box, a screw conveyer at a central portion of the machine frame, and a second grind-type grain cleaning machine at a lower portion of the machine frame in the shape of the longitudinal box are respectively arranged in a unified manner, thus forming a long-operation grain cleaning machine.

20. A horizontal grind-type grain cleaning machine in which a plurality of horizontal grind-type grain cleaning machines according to claim 6 are connectedly provided, wherein a first grind-type grain cleaning machine at an upper portion of a machine frame in a shape of a longitudinal box, a screw conveyer at a central portion of the machine frame, and a second grind-type grain cleaning machine at a lower portion of the machine frame in the shape of the longitudinal box are respectively arranged in a unified manner, thus forming a long-operation grain cleaning machine.
